(19) United States
(12) Patent Application Publication
(10) Pub. No.: US 2003/0173461 A1
(43) Pub. Date: Sep. 18, 2003

(54) Spaceshuttle forked observatory

(76) Inventor: Zoltan Herpay, London (GB)

Correspondence Address: DR ZOLTAN HERPAY, 28 Dudley Court, 36 Endell Street, London, WC2 9RD, GB

(21) Appl. No.: 10/100,728

(22) Filed: Mar. 18, 2002

(51) Int. Cl. B64G 1/22; B64G 1/00

(52) U.S. Cl. 244/158 R

(57) ABSTRACT

A Spaceshuttle Forked Observatory of a singular ultralight system, in which the Spaceshuttle is a self-lifting body, capable of doing reentry, together with its forked and base-rotated telescope and observatory when this latter part is closed into the nose-cone of a large fuselage, but in the working or space-conditions the fork could rotate in the fuselage, the telescope could rotate in the fork, and the frontal, as well as the back part of the telescope could be made longer telescopically, but not necessarily, and the opening star-doors of the telescope could save the frontal secondary with their outer ablation layers in reentry, in which a large frontal landing geer could be lowered before touch-down. Nothing is planned to be jettisoned. The telescope could be operative with a five meters wide main reflector, and the big Spaceshuttle could stay in space for a long time.

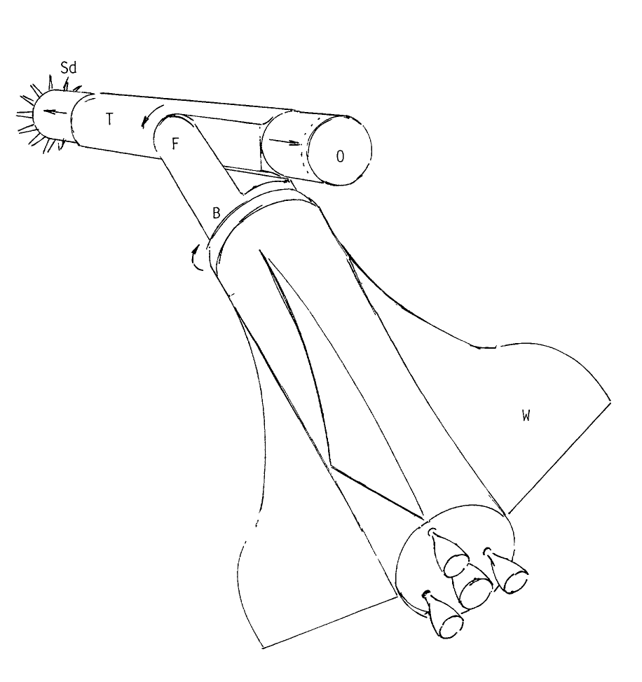

This invention relates to a Spaceshuttle Forked Observatory.

The Spaceshuttle is known by everybody ever since I submitted my British Provisional Patent Application of my Aero-space Flying Observatory in 1967, from which the NASA created its own Spaceshuttle, by cutting out its observatory part. The forked telescope mounting is also known. Less known is the fact that a telescope could be housed with an ultralight main reflector, whose adjacent base is the observatory. When these are integrated, several problems could be solved, but the task is never easy.

According to the present invention there is provided a Spaceshuttle Forked Observatory, comprising a large and completely reworked Spaceshuttle, capable of lifting itself together with its accessories and it is also capable of doing a reentry, loosing practically nothing but its surface coatings, known as ablation materials, however, in space conditions its fuselage-based rotating fork could accommodate a large telescope with its fork-rotation, which is having a telescope-opening star-door system at one end, and a rather closed observatory with a main-reflector at another end. These could be supplied with solar power from the large shuttle-wings, tail and fuselage surfaces. The fuselage is planned to be rather wide and strong, operative with big engines. Nothing is planned to be jettisoned. The length of the whole could be around 80 meters. From this the length of the telescope could be 32 meters. The span of the wings could be 40, 44 meters. The most essential part of the system, the large main-reflector could be a very light, almost zero-thermal-expansion-coefficient metallic foam body with a thin silical skin on its surface that could offer a high quality work with easy crontrolling from its backing observatory, the only manned part. Lettered with O.

A specific embodiment of the invention will now be described by way of example with reference to the accompanying drawing, which is a singular perspective view of the system, lettered with Sd, T, F, B, O and W.

Refferring to the drawing, the letters Sd, or the star-door at the top nose-cone of the telescope is a plurality of long triangular doors, T is the telescope, F represents the fork and its special rotational freedom, B represents the base-circle under the fork on the frontal part of the fuselage that could offer another rotation, however the large wings W are not employing tip-rotations, but they are covered almost completely with solar-radiation collecting surfaces. A number of moving parts, but none of them are detrimental.

If properly made, this system could offer an advancement in scientific knowledge, based on observational facts as well as on good theories.

1. A Spaceshuttle Forked Observatory comprising a winged large lifting and reentry accommodating body that holds on its big fuselage-nose a rotary fork, whose base rotates around the central axis of the fuselage, but in the inner parts of the forks a great telescope could rotate vertically, for making the telescope and its observatory useful for long-time works, while the body of the Spaceshuttle could collect solar-radiation, as beeing capable of following the movements of the sun. The end-parts of the telescope could be pulled out.

2. A Spaceshuttle Forked Observatory as claimed in clain 1 which is using a star-door at its opening in a close vicinity with the secondary reflector but at the opposite end of the telescope there is a large light-weight main-reflector, backed by a rather wide and deep observatory.

3. A Spaceshuttle Forked Observatory as claimed in claim 1 and 2, in which only the fuselage of the large winged body is wider somewhat, and filled with fuel, especially in the lift-up, but the large wing surfaces are covered with solar-radiation collecting surface layers on the top part.

4. A Spaceshuttle Forked Observatory as claimed in the previous claims, in which the telescope could lower a frontal landing geer before touch-down, though the telescope is not necessarily closed back to the line of the fuselage in the fork-rings, and its touch down may look like that of the Concord, with a very high angle of attack of the Spaceshuttle part, and a slightly negative angle of attack of the telescope.

5. A Spaceshuttle Forked Observatory as claimed in any of the previous Claim points, in which the observatory could be made well manned, but the shuttle in itself is unmanned.
